(19) United States
(12) Patent Application Publication
(10) Pub. No.: US 2025/0285365 A1
(43) Pub. Date: Sep. 11, 2025

(54) GENERATING AN IMAGE BASED ON A RENDERED IMAGE

(71) Applicant: Disguise Technologies Limited, London (GB)

(72) Inventor: Dominic Brown, London (GB)

(73) Assignee: Disguise Technologies Limited, London (GB)

(21) Appl. No.: 18/862,519

(22) PCT Filed: Apr. 28, 2023
(86) PCT No.: PCT/GB2023/051146

§ 371 Date: Nov. 1, 2024

(30) Foreign Application Priority Data
May 2, 2022 (GB) 2206378.8

(51) Int. Cl. G06T 15/20; G06T 5/77; G06T 5/80; G06T 7/80

(52) U.S. Cl. CPC G06T 15/205; G06T 5/77; G06T 5/80; G06T 7/80; G06T 2200/04; G06T 2207/20021; G06T 2207/30244

(57) ABSTRACT

The present disclosure relates to a computing device for generating an image configured to be captured by a camera. The computing device being configured to determine an image to be rendered associated with at least one camera pose and then render said image, receive information on a current camera pose, and generate an image associated with the current camera pose based on the rendered image associated with the at least one camera pose.

### FIELD OF THE DISCLOSURE

The present disclosure relates to computing devices, systems and methods for generating an image based on a rendered image.

### BACKGROUND

Rendering of a two-dimensional or three-dimensional model or scene by means of a computer program enables extended reality to be applied to various sectors including the film, broadcasting and live event industries. For example, for film production, instead of using a green screen to provide a background to a scene, virtual content can be rendered and displayed on a large screen as an actor is performing in front of the screen whilst a camera captures the actor and the rendered content. This technique enables the rendered virtual content to be composited with live action content in real time. In broadcasting and live events, virtual content can be rendered in real time and displayed on a user device such as a mobile phone or head-mounted display (HMD) to give a user a personalised extended reality experience. The virtual content can be mixed with real content as it is displayed depending on the application.

Rendering virtual content in real time may require large number of computational resources depending on the rate of viewpoints that need to be rendered, complexity of the content as well as number of users wishing to access the content. An important aspect in creating a convincing virtual environment for film production, broadcasting and live events, or any other extended reality application, is that the perspective of the rendered frames or images matches that of the camera capturing the frames, or that of a user device displaying the projected the rendered frames.

### BRIEF SUMMARY OF THE DISCLOSURE

According to an aspect of the present disclosure, there is provided a computing device for generating an image configured to be captured by a camera, which may be suitable for compositing virtual and live action content. The computing device being configured to determine an image to be rendered associated with at least one camera pose and then render said image, receive information on a current camera pose, and generate an image associated with the current camera pose based on the rendered image associated with the at least one camera pose.

By the computing device generating an image based on an already rendered image, whilst taking into account the difference in perspective of the images or pose of the camera, the computing power required can be reduced as speculative images do not have to be rendered in the hope that one may match the actual pose of the camera. Additionally, latency can also be reduced as there a fewer message being sent across the network in order to display an image of relevant perspective.

The perspective of the image associated with the current camera pose may be different to the perspective of the rendered image of the at least one camera pose. This may mean that the generated image has a different perspective than the rendered image. As such, an image does not have to be rendered for each perspective or camera pose but can instead be generated which requires less computational power. It also reduces latency as it is much quicker to generate an image as disclosed herein, rather than rendering an image where various components are involved.

The computing device may be configured to generate the image associated with the current camera pose based on depth information and/or geometric information of the rendered image associated with the at least one camera pose. Alternatively or additionally, the image can be generated based on any suitable geometric scene representation of the rendered image forming basis for the generated image.

In one example, the at least one camera pose may be a predicted at least one camera pose. This may mean that the computing device is configured to predict the at least one camera pose, and render an image associated with the camera pose. Thereafter, the computing device may generate an image corresponding to the actual or current camera pose based on the rendered predicted camera pose. It should be realised that this is useful when the camera moves but does not assume the predicted camera pose but assumes a pose near the predicted camera pose.

In one example, the at least one camera pose may be a previous camera pose. This may mean that the computing device is configured to determine a previous camera pose, which may be the last known camera pose(s). Then based on a rendered image previous camera pose, a new image is generated corresponding to the actual camera pose. It should be realised that this is useful when there are incremental changes in the camera's pose.

The computing device may be configured to generate the image associated with the current camera pose by deprojecting content of the image associated with the at least one camera pose from a two-dimensional screen space to its position in a three-dimensional world space using an inverse of the at least one camera pose's view projection matrix, and applying a view projection matrix of the current camera pose to the position of the content in the three-dimensional world space so that the image of the current camera pose can be projected in a two-dimensional screen space. This enables the generated image to have a perspective and parallax effect matching or corresponding to the current camera pose.

The image associated with the current camera pose may be generated by pixel reprojection or mesh reprojection as described herein.

In one example, the computing device may be further configured to divide the image associated with the at least one camera pose into a mesh, perform deprojection by warping and moving the mesh based on said image's depth map and use the inverse of the at least one camera pose's view projection matrix, and then apply the view projection matrix of the current camera pose so that the image can be projected in a two-dimensional screen space.

In one example, the at least one camera pose may comprise a plurality of camera poses, the computing device being configured to render a plurality of images each of which is associated with a corresponding camera pose, based on the received information on the current camera pose, select the camera pose of the plurality of camera poses closest in matching the current camera pose, and generate an image associated with the current camera pose based on the selected camera pose and at least one further image associated with the plurality of camera poses. This may mean that several camera poses are predicted and an image is generated based on two rendered images, one of which is the closest to the actual camera pose. It may also mean that several known camera poses are considered, and an image is generated based on two previously rendered images, one of which is the closest to the actual camera pose. An image can also be generated based on a rendered image associated with a predicted camera pose and a rendered image associated with a previous camera pose.

In the example of a plurality of camera poses as described above, the computing device may be further configured to generate the image associated with the current camera pose by deprojecting content of the image associated with the selected camera pose from a two-dimensional screen space to its position in a three-dimensional world space using an inverse of the selected camera pose's view projection matrix, and applying a view projection matrix of the current camera pose to the position of the content in the three-dimensional world space so that the image of the current camera pose can be projected in a two-dimensional screen space.

The image associated with the current camera pose may be generated by pixel reprojection or mesh reprojection as described herein.

In one example, the computing device may be further configured to divide the image associated with the selected camera pose into a mesh, perform deprojection by warping and moving the mesh based on said image's depth map and use the inverse of the view projection matrix of the selected camera pose, and then apply the view projection matrix of the current camera pose so that the image can be projected in a two-dimensional screen space.

The computing device may be further configured to perform inpainting for filling in a disoccluded area in the generated image associated with the current camera pose, wherein the inpainting is based on an image associated with the at least one camera pose. Here, the at least one camera pose may be a predicted or known camera pose. Also, the inpainting may be based on the rendered image used for generating the image or it may be based on another neighbouring rendered image, or a combination thereof.

The inpainting may be based on surface normal information of an object in the image associated with the at least one camera pose.

The inpainting may be further based on albedo and ambient occlusion information of the image associated with the least one camera pose.

According to another aspect of the disclosure, a method for generating an image is provided. The method comprises determining an image to be rendered associated with at least one camera pose and then rendering said image. The method further comprises receiving information on a current camera pose and generating an image associated with the current camera pose based on the image associated with the at least one camera pose. The perspective of the image associated with the current camera pose may be different to the perspective of the image of the at least one camera pose.

The method may further comprise generating the image associated with the current camera pose based on depth information and/or geometric information, or any other scene geometry representation, of the image associated with the at least one camera pose.

The method may also comprise generating the image associated with the current camera pose by deprojecting content of the image associated with the at least one camera pose from a 2D screen space to its position in a 3D world space using an inverse of the at least one camera pose's view projection matrix, and applying a view projection matrix of the current camera pose to the position of the content in the 3D world space so that the image of the current camera pose can be projected in a 2D screen space.

The image associated with the current camera pose may be generated by pixel reprojection or mesh reprojection as described herein.

In one example, the method may comprise dividing the image associated with the at least one camera pose into a mesh, performing deprojection by warping and moving the mesh based on said image's depth map and using the inverse of the at least one camera pose's view projection matrix, and then applying the view projection matrix of the current camera pose so that the image can be projected in a two-dimensional screen space.

In one example, the at least one camera pose comprises a plurality of camera poses, and the method may further comprise rendering a plurality of images each of which is associated with a corresponding camera pose, based on the received information on the current camera pose, the method may further comprise selecting the camera pose of the plurality of camera poses closest to the current camera pose. The method may then further comprise generating an image associated with the current camera pose based on the selected camera pose and at least one further image associated with the plurality of camera poses.

Generating the image associated with the current camera pose may comprise deprojecting content of the image associated with the selected predicted camera pose from a 2D screen space to its position in a 3D world space using an inverse of the selected predicted camera pose's view projection matrix, and applying a view projection matrix of the current camera pose to the position of the content in the 3D world space so that the image of the current camera pose can be reprojected in a 2D screen space.

In one example, the method may comprise dividing the image associated with the selected predicted camera pose into a mesh, performing deprojection by warping and moving the mesh based on said image's depth map and using the inverse of the selected predicted camera pose's view projection matrix, and then applying the view projection matrix of the current camera pose so that the image can be projected in a two-dimensional screen space.

The method may further comprise performing inpainting for filling in a disoccluded area in the generated image associated with the current camera pose, wherein the inpainting is based on an image associated with the at least one camera pose. The inpainting may be based on surface normal information, albedo and/or ambient occlusion information of the image associated with the at least one camera pose as discussed herein.

According to another aspect of the disclosure, a system comprising a computing device for generating an image, a display for displaying the rendered image, and a camera configured to capture the rendered image displayed on the display is provided. The computing device may be any computing device disclose herein.

According to another aspect of the disclosure, a system comprising a computing device for generating an image, a display for displaying the rendered image, and a camera configured to capture the rendered image displayed on the display is provided. The computing device may be configured to determine a plurality of camera poses and render an image for each camera pose, the camera comprising at least one sensor for detecting a current camera pose, and the camera being configured to transmit its current pose to the computing device, the computing device being further configured to select a determined camera pose of the plurality of camera poses closest in matching the current camera pose, and generate an image associated with the current camera pose based on at least one image of the plurality of determined camera poses, the display being configured to display the generated image whilst the camera is in its current pose and captures the generated image. The computing device may be further configured to perform any of the methods described herein.

According to another aspect of the disclosure, there is provided a computing device for generating an image for displaying on a first device, The computing device being configured to determine a pose of a first device having a display, identify at least one second device having a display, wherein the at least one second device has a pose different to the first device, render an image associated with the pose of the at least one second device, generate an image associated with the pose of the first device based on the image associated with the pose of the at least one second device.

This may mean that rather rendering content for several devices in real time, content can be rendered for some devices and for the remaining devices content can be generated based on the rendered content. This may be particularly useful in scenarios where devices simultaneously display the same content/environment but from a different perspective, for example the content may be an extended reality of a concert or show.

The computing device may be configured to generate the image associated with the pose of the first device by using depth information and/or geometric information, or other suitable geometric scene representation of the image associated with the pose of the at least one second device.

The computing device may be configured to generate the image associated with the pose of the first device by deprojecting content of the image associated with the pose of the at least one second device from a two-dimensional screen space to its position in a three-dimensional world space using an inverse of the at least one second device's view projection matrix, and applying a view projection matrix of the first device to the position of the content in the three-dimensional world space so that the image of the first device can be projected in a two-dimensional screen space.

The image associated with the pose of the first device may be generated by pixel reprojection or mesh reprojection as described herein.

In one example, the computing device may be further configured to divide the image associated with the pose of the at least one second device into a mesh, perform deprojection by warping and moving the mesh based on said image's depth map and use the inverse of the view projection matrix of the pose of the at least one second device, and then apply the view projection matrix of the pose of the first device so that the image can be projected in a two-dimensional screen space.

In one example, the at least one second device comprises a plurality of second devices differing in poses, and the computing device is configured to render an image associated with each second device such that a plurality of images is rendered, determine the pose of each plurality of second devices, and select the second device closest in matching the pose of the first device, and generate an image associated with the first device based on the image of the selected second device and at least one further image associated with another second device. This may be useful when there are several second devices each of which is rendering content of different perspectives.

The computing device may be configured to generate the image associated with the pose of the first device by deprojecting content of the image associated with the pose of the selected second device from a two-dimensional screen space to its position in a three-dimensional world space using an inverse of the second device's view projection matrix, and applying a view projection matrix of the first device to the position of the content in the three-dimensional world space so that the image of the first device can be projected in a two-dimensional screen space.

The image associated with the pose of the first device may be generated by pixel reprojection or mesh reprojection as described herein.

In one example, the computing device may be further configured to divide the image associated with the pose of the selected second device into a mesh, perform deprojection by warping and moving the mesh based on said image's depth map and use the inverse of the view projection matrix of the pose of the selected second device, and then apply the view projection matrix of the pose of the first device so that the image can be projected in a two-dimensional screen space.

The computing device may be further configured to perform inpainting information for filling in a disoccluded area in the generated image associated with the first device, wherein the inpainting is based on an image associated with at least one second device.

The inpainting may be based on surface normal information of an object in the image associated with the at least one second device. Here, the inpainting may be based on the rendered image used for generating the image or it may be based on another neighbouring rendered image of another second device, or a combination thereof.

The inpainting may further based on albedo and ambient occlusion information of the image associated with the least one second device.

According to another aspect of the disclosure, there is provided a method for generating an image for displaying on a first device. The method comprises determining a pose of a first device having a display, and identifying at least one second device having a display, wherein the at least one second device has a pose different to the first device. The method further comprises rendering an image associated with the pose of the at least one second device, and generating an image associated with the pose of the first device based on the image associated with the pose of the at least one second device.

The method may further comprise generating the image associated with the pose of the first device by using depth information and/or geometric information, or any other scene geometry representation, of the image associated with the pose of the at least one second device.

The method may comprise generating the image associated with the pose of the first device by deprojecting content of the image associated with the pose of the at least one second device from a 2D screen space to its position in a 3D world space using an inverse of the at least one second device's view projection matrix, and applying a view projection matrix of the first device to the position of the content in the 3D world space so that the image of the first device can be reprojected in a 2Dscreen space.

The image associated with the pose of the first device may be generated by pixel reprojection or mesh reprojection as described herein.

In one example, the method may comprise dividing the image associated with the pose of the at least one second device into a mesh, performing deprojection by warping and moving the mesh based on said image's depth map and using the inverse of the view projection matrix of the pose of the at least one second device, and then applying the view projection matrix of the pose of the first device so that the image can be projected in a two-dimensional screen space.

In one example, the at least one second device comprises a plurality of second devices differing in poses, and the method comprises rendering an image associated with each second device such that a plurality of images is rendered, determining the pose of each plurality of second devices, and selecting the second device closest in matching the pose of the first device, and generating an image associated with the first device based on the image of the selected second device and at least one further image associated with another second device. In this example, the method may also comprise generating the image associated with the pose of the first device by deprojecting content of the image associated with the pose of the selected second device from a 2D screen space to its position in a 3D world space using an inverse of the second device's view projection matrix, and applying a view projection matrix of the first device to the position of the content in the 3D world space so that the image of the first device can be projected in a 2D screen space.

The image associated with the pose of the first device may be generated by pixel reprojection or mesh reprojection as described herein.

In one example, the method may comprise dividing the image associated with the pose of the selected second device into a mesh, performing deprojection by warping and moving the mesh based on said image's depth map and using the inverse of the view projection matrix of the pose of the selected second device, and then applying the view projection matrix of the pose of the first device so that the image can be projected in a two-dimensional screen space.

The method may further comprise inpainting information for filling in a disoccluded area in the generated image associated with the first device, wherein the inpainting is based on an image associated with at least one second device. The inpainting may be based on surface normal information of an object in the image associated with the at least second device. The surface normal information may be extracted from the image associated with the at least second device and applied to the generated image. The inpainting may further comprise albedo and ambient occlusion information of the image associated with the least one second device. The albedo and ambient occlusion information may be extracted from the image associated with the at least one second device and applied to the generated image.

According to another aspect of the disclosure, there is provided a computing device for generating an image, the computing device being configured to receive a first image depicting an object from a perspective, generate a new image based on depth information and/or geometric information, or other scene geometry representation of the first image, wherein the new image is depicting the object from a different perspective to the first image, and perform inpainting for filling in a disoccluded area in the new image, wherein the inpainting is based on surface normal information of the first image and/or at least another image different to the first image.

The surface normal information may be extracted from the first image and/or the at least another image and applied to the new image. The inpainting may further comprise albedo and ambient occlusion information of the first image and/or the at least another image. The albedo and ambient occlusion information may also be extracted from the first image and/or the at least another image. The first image and the at least one another image may be of different perspectives and so contain different information or complementary information used for generating the new image.

According to another aspect of the disclosure, there is provided a method for generating an image, the method comprises receiving a first image depicting an object from a perspective, generating a new image based on depth information and/or geometric information, or other scene geometry representation of the first image, wherein the new image is depicting the object from a different perspective to the first image, and performing inpainting for filling in a disoccluded area in the new image, wherein the inpainting is based on surface normal information of the first image and/or at least another image different to the first image.

According to another aspect of the disclosure, there is provided a method for generating an image, the method comprises receiving a first image depicting an object from a perspective, generating a new image depicting the object from another perspective by dividing the image associated with the pose of the selected second device into a mesh, performing deprojection by warping and moving the mesh based on said image's depth map and using the inverse of the view projection matrix of the pose of the selected second device, and then applying the view projection matrix of the pose of the first device so that the image can be projected in a two-dimensional screen space. Any inpainting and/or filling method described herein may be further applied to the new image.

According to another aspect of the disclosure, there is provided a computer readable medium having instructions stored thereon, which when executed by a processor or processing unit, causes the processor to implement a method or methods described herein.

A computer program which, when run on a computer, causes the computer to carry out a method as described herein.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all examples and/or features of any example can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a schematic illustration of a system for producing virtual content composited with live action;

FIG. 2a is a schematic illustration of a computing device for generating an image configured to be captured by a camera;

FIG. 2b is a schematic illustration of different deprojection and reprojection methods;

FIG. 3 is a flow chart of a method for generating an image configured to be captured by a camera;

FIG. 4 is a schematic illustration of a computing device for generating an image for displaying on a user device;

FIG. 5 is a flow chart of a method for generating an image for displaying on a user device;

FIG. 6 is a schematic illustration of a computing device for generating an image;

FIG. 7 is a flow chart of a method for generating an image;

FIG. 8 is a schematic illustration of a computing device which may be used to implement aspects of one or more methods described herein;

FIG. 9 is a schematic illustration of a system 900 for producing virtual content composited with live action; and

FIG. 10 is a schematic illustration of a computing device for generating an image for displaying on a user device.

### DETAILED DESCRIPTION

As mentioned in the background section, rendering images in real time can require a vast amount of computational power and resources, in particular when creating a virtual environment that needs to match the perspective of a user or a camera in order to be convincing.

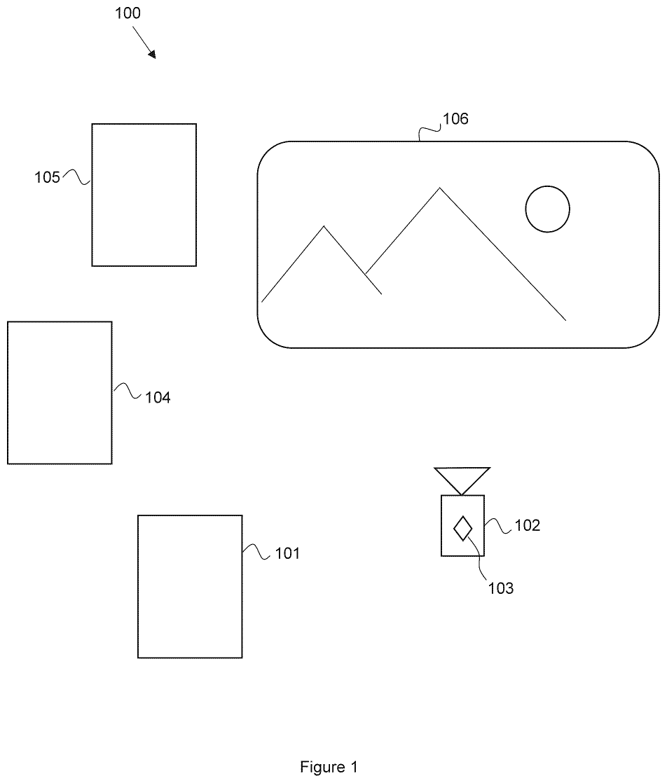

For example, in the film industry, the background of a scene can be rendered in real time rather than applied in postproduction, however it is important that the perspective of the background matches the perspective of the camera as will now be explained in more detail. An example of a system 100 for producing virtual content composited with live action is shown in FIG. 1. The system comprises a network of components that can communicate with one another through a wired and/or wireless connection using TCP/IP messaging protocols. The components of the system 100 include a compositing server 101 which acts a central hub of the system, a camera 102 configured to communicate with the main compositing server 101, a tracker 103 configured to track the pose and intrinsics of the camera. The tracker 103 may be attached to the camera 102. The components of the system 100 further include a dedicated server 104 configured to receive the tracked pose and intrinsics of the camera, record the pose and intrinsics and transmit it to the compositing server 101. The system also comprises a rendering server 105 configured to render frames of virtual content and transmitting the rendered frames to the compositing server 101. The system 100 further comprises a display 106, for example an LED display, for projecting or displaying the rendered frames.

In use, the camera may move as it records the rendered content displayed on the display. The camera's 102 pose and intrinsics are tracked using the tracker 103. More specifically, the tracker 103 determines the camera's location, orientation and/or intrinsics as tracking information, and transmits the tracking information to the dedicated server 104. The dedicated server 104 transmits the tracking information to the compositing server 101 which in turns determines, based on the tracking information, a frame of the virtual content to render that corresponds to the camera's pose. The compositing server 101 then instructs the rendering server 105 to render the determined frame and to project the frame onto the display 106. Once the frame is projected onto the display 106, the camera 102 can capture or film the display 106 as well as any actors and props positioned in front of the display 106.

It is important that the rendered frame corresponds to the camera's perspective so that virtual content can be combined with real, on-set actors and props, creating a composite image that places real life objects within virtual environments with correct perspective and parallax effects.

Challenges with this system arises when the camera's pose changes as the projected frame needs to be updated to correspond with the new perspective of the camera. The steps of the tracker 103 sending updated tracking information to the dedicated server 104 which updates the compositing server 101, which in turn computes which frame to render and instructing the rendering server 105 accordingly, and thereafter projecting the rendered frame on the display 106 comes with an inherent latency. At the point when the rendered frame is displayed on the display 106, the camera may have already changed its pose such that the displayed frame does not correspond to the camera's current pose.

To overcome this, it can be envisaged that the rendering server 105 can render a large number of frames corresponding to a predicted camera pose with the aim that at least one rendered frame matches the actual camera pose. However, rendering a large number of frames requires a vast amount of computational power and it puts an unnecessary burden on the system without a guaranteed match between the final chosen frame and the eventual camera pose.

In another example, where a display of a user device is displaying rendered frames to provide a virtual environment, the perspective of each displayed frame needs to match the perspective of the user device in order for the virtual content to be convincing. This application may also require a vast amount computational resources in particular when the user device is moved changing the perspective and new frame needs to be rendered in order to take into account for the change in perspective. Also, if there is an audience with each member viewing extended reality content on their personal user device simultaneously (e.g. mobile phone or head mounted display, HMD) then frames need to be rendered for each user device having a different perspective which requires a vast amount of computational resources. These types of applications may also be prone to latency from the point that a user device sends its pose to a rendering server to when it receives a rendered frame for projection or display.

Certain examples of the present disclosure may attempt to reduce computational resources required for rendering images and/or reduce latency experienced by a system rendering images whilst providing a convincing perspective and parallax effect of the images as they are displayed on a display.

In the following description, for purposes of explanation, numerous specific details of certain examples are set forth. Reference in the specification to “an example” or similar language means that a particular feature, structure, or characteristic described in connection with the example is included in at least that one example, but not necessarily in other examples. It should also be understood that features of one example may be applied to another example, if so feasible, although not explicitly described.

For the purposes of this description, the terms frame, viewpoint and image are to be understood as having the same meaning and are used interchangeably. Furthermore, a frame is to be understood as a two-dimensional or three-dimensional representation of a three-dimensional scene or model. Additionally, it should be understood that a frame is associated with information describing the frame's geometry and pose of a camera or device, wherein for the purposes of this description, pose includes location and/or orientation, and optionally also intrinsic(s) of the camera used to render or capture the frame.

For the purposes of this description, a camera should be understood as a camera configured to record or film a video displayed on a screen, wherein the camera may be stationary and configured to change orientation, and/or the camera may be configured to move and so change location. In other examples, a camera may refer to a synthetic camera model or object in computer graphics.

As used herein a generated image is to be understood as an image that has been created or synthesised based on a rendered image or information of a rendered image. The information of a rendered image may be scene geometry representation such as geometric information and/or depth information. A rendered image is to be understood as a two-dimensional image created or rendered from a two-dimensional or three-dimensional model by means of a computer or computer program.

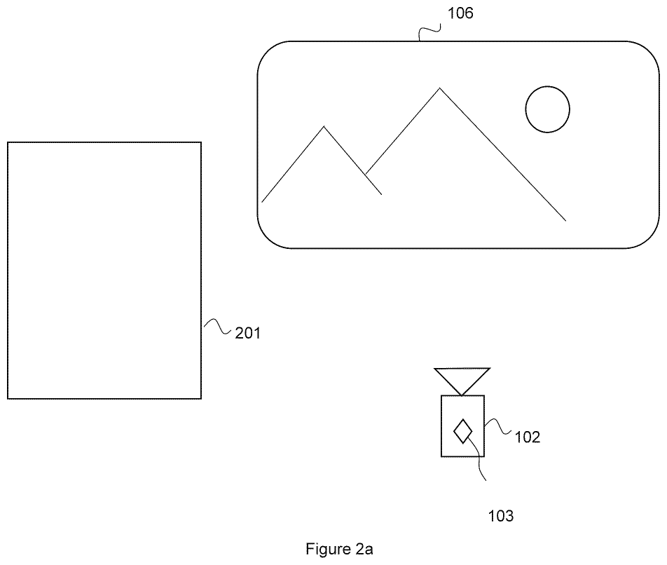

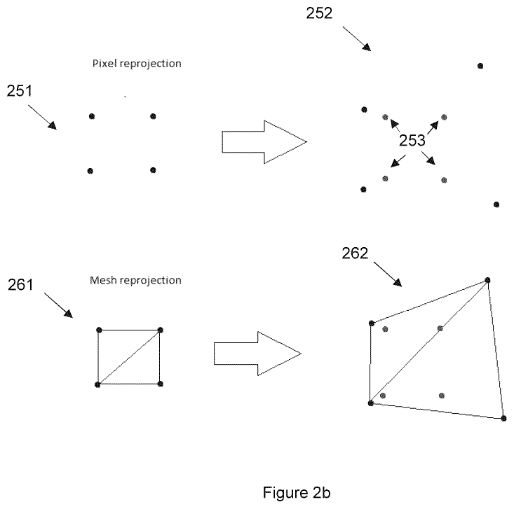

FIG. 2a illustrates a computing device 201 for generating an image configured to be suitable for capturing by a camera 102, wherein the camera 102 may form part of the system shown in FIG. 1. Here, an image configured to be suitable for capturing by a camera may mean an image that has a perspective corresponding to the pose of a camera configured to capture the image.

The computing device 201 is configured to determine an image to be rendered associated with at least one camera pose and then render said image, receive information on a current camera pose, and generate an image associated with the current camera pose based on the image associated with the at least one camera pose.

By the computing device generating an image based on an already rendered image, whilst taking into account the difference in perspective, the computing power required can be reduced as speculative images do not have to be rendered in the hope that one may match the actual pose of the camera. Additionally, latency can also be reduced as there are fewer messages being sent across the network in order to display an image of relevant perspective.

The computing device may be a server, several servers, a compositing server, rendering server, dedicated server, computer or other hardware that has computational capabilities. The computing device may comprise an input and an output interface for communicating with other components such as a camera 102, tracker 103 and/or display 106 configured to display content.

The computing device may receive information on a current camera pose and previous camera pose(s) from a tracking device tracking the pose and optionally also the intrinsic(s) of the camera.

As previously described, the term camera pose or pose of a camera as used herein is to be understood as a location and/or orientation of a camera and optionally also the intrinsics of the camera. Intrinsics used herein is to be understood as intrinsic parameter(s) of a camera. Examples of intrinsics may be focal length, lens distortion, resolution, pixel dimension and/or optical length of the camera. The camera is configured to capture or record rendered content displayed on a display 106. The pose of the camera may be tracked using a tracking device such as an accelerometer, gyroscope, GPS and/or simultaneous localisation and mapping (SLAM) or other suitable technology. The recent history and/or current camera pose may be used to predict an upcoming camera pose.

It is to be understood that the perspective of the image associated with the current camera pose as described above may be different to the perspective of the image of the at least one camera pose. Also, in one example, the at least one camera pose may be at least a predicted camera pose and/or at least one previous or assumed camera pose, for example the last known camera pose. To explain further, the computing device 201 may predict at least one future camera pose, determine an image to be rendered associated with the at least one predicted camera pose and then render said image, receive information on a current camera pose, generate an image associated with the current camera pose based on the image associated with the at least one predicted camera pose. Alternatively, or additionally, the computing device may determine an image to be rendered associated with at least one known or previous camera pose, this pose may for example be the last known camera pose, and render the image if not already rendered, receive information on a current camera pose, generate an image associated with the current camera pose based on the image associated with the at least one previous camera pose.

The computing device 201 may be further configured to generate the image associated with the current camera pose based on depth information and/or geometric information of the image associated with the at least one camera pose. Depth information indicates the distance of a pixel from the camera and in deferred rendering depth information is included in a depth buffer or G-buffer. Geometric information indicates edges and/or vertices of an object(s) in an image. In some examples, the computing device is configured to generate the image associated with the current camera pose based on any scene geometry representation, for example, depth information as previously described or a mesh comprising information on vertices and faces.

In one example, the computing device 201 may be configured to generate the image associated with the current camera pose by deprojecting content of the image associated with the at least one camera pose from a two-dimensional (2D) screen space to its position in a three-dimensional (3D) world space using an inverse of the at least one camera pose's view projection matrix, and then applying a view projection matrix of the current camera pose to the position of the content in the 3D world space so that the image of the current camera pose can be reprojected in a 2D screen space. This may further be explained as inverting the view projection matrix of the at least one camera pose and multiplying the matrix with the x, y, and z coordinates of each pixel of the 2D screen space (here the z-coordinates may correspond or be determined by the depth information, which may be included in the depth buffer, G-buffer, depth map or any other scene geometry representation as described above). This causes each pixel to be returned to its original x, y, z location in a 3D world space. The locations of each original x, y, z location in a 3D world space are then multiplied with the view projection matrix of the actual (or current) camera pose so that the image of the actual pose can be reprojected in a 2D screen space with the right perspectives. A view projection matrix is a known concept within the field of rendering a 3D model into 2D and it is to be understood as the view matrix multiplied by or combined with the projection matrix.

The reprojection of the image as described above can be applied to each pixel directly herein referred to as pixel reprojection, or it can be achieved by reprojecting the geometric representation of the 3D scene in 2D and then determine the final pixel position or rather pixel colour through interpolation, herein referred to as mesh projection. Mesh projection may be understood as reprojecting a mesh or vertices rather than pixels as in pixel reprojection. Furthermore, when reprojecting a mesh or vertices a relationship or connection between its pixels is considered or included in the reprojection such that any disoccluded areas in the generated image can be filled in based on interpolation of the known pixel values. This is achieved by dividing the 2D image associated with the at least one camera pose into a grid or mesh, then deproject by warping and moving the image based on its depth map and use the inverse view projection matrix associated with the at least one camera pose, and thereafter render the deformed image by applying the view projection matrix of the current camera pose such that it becomes a 2D image of the current perspective of the camera.

A further explanation of the reprojection by pixel and reprojection by vertices or mesh will now be described with reference to FIG. 2b. FIG. 2b illustrates pixel reprojection where in a rendered image 251 pixels are shown in a 2D space and when reprojected in 2D space in a generated image 252 the pixels have moved leaving behind pixels 253 that need to be filled in with a colour, for example with inpainting. FIG. 2b further illustrates mesh reprojection where in a rendered image 261 pixels are shown in a 2D space. The vertices associated with these pixels are deprojected and reprojecting in a 2D space to generate an image 262 and an inter-vertex relationship is maintained through the mesh or vertices. By using a mesh or vertices the colour for the pixels that now need to be filled and located within the triangles shown in image 262 can be interpolated such that there is no need or reducing the need for inpainting.

In another example, the computing device 201 may be configured such that it determines images to be rendered, each image being associated with a corresponding camera pose such that there is a plurality of camera poses, and based on the received information on the current camera pose, the computing device is further configured to select the camera pose of the plurality of camera poses closest to the current camera pose. The computing device 201 then generates an image associated with the current camera pose based on the selected camera pose and at least one further image associated with the plurality of camera poses. Similar to above, the image can be generated based on depth information, geometric information and/or any other scene geometry representation of the image associated with the selected camera pose.

Furthermore, the selected camera pose may be used for deprojection and reprojection as described above. Additionally or alternatively, the at least one further image may be used for inpainting as is described below. With regard to the deprojection, the computing device 201 may be configured to generate the image associated with the current camera pose by deprojecting content of the image associated with the selected camera pose from a 2D screen space to its position in a 3D world space using an inverse of the selected camera pose's view projection matrix, and applying a view projection matrix of the current camera pose to the position of the content in the 3D world space so that the image of the current camera pose can be reprojected in a 2D screen space. Similar to above, this may further be explained as inverting the view projection matrix of the selected camera pose and multiplying the matrix with the x, y, and z coordinates of each pixel of the 2D screen space (here the z-coordinates may correspond or be determined by the depth information, which may be included in the depth buffer, G-buffer, depth map or any other scene geometry representation as described above). This causes each pixel to be returned to its original x, y, z location in a 3D world space. The locations of each original x, y, z location in a 3D world space are then multiplied with the view projection matrix of the actual (or current) camera pose so that the image of the actual pose can be reprojected in a 2D screen space with the right perspectives.

The deprojection of the image associated with the selected camera pose and the reprojection of the image associated with the actual camera pose as described in the preceding paragraph can be performed using either pixel reprojection or mesh reprojection as described herein.

It should be understood that when the at least one camera pose comprises a plurality of camera poses as described above, then the plurality of camera poses may be predicted camera poses and/or previous/known camera poses. To explain further, the computing device 201 may predict a plurality of future camera poses, determine an image to be rendered for each camera pose and then render said images, and receive information on a current camera pose, for example from a tracking device. The computing device may then select the predicted camera pose of the plurality of camera poses closest to the current camera pose, and generate an image associated with the current camera pose based on the image associated with the selected predicted camera pose. Alternatively, or additionally, the computing device may determine an image to be rendered associated with at least one known or previous camera pose, this pose may for example the last known camera pose, and render the image if not already rendered. The computing device may then receive information on a current camera pose and then select the previous known camera pose of the plurality of camera poses closest to the current camera pose, and generate an image associated with the current camera pose based on the image associated with the selected known camera pose.

It should be understood that the generated image does not have to be based on the image associated with the predicted or previous pose that is closest to the actual pose of the camera 102. The generated image can be based on an image associated with a predicted pose or previous pose that is just close to the actual pose of the camera 102.

As the generated image has a different perspective to the rendered image on which it is based, there may be disocclusions appearing in the generated image. A disocclusion is an area that appears when content in the foreground of an image moves more than the background, disoccluding a region in the background. In this case, a disocclusion is an area that were occluded by an object in the rendered image but visible in the generated image. Disocclusions may be avoided or reduced by using the mesh reprojection described herein where the final pixel position or rather pixel colour is determined through interpolation. Additionally or alternatively, disocclusions may be filled in real time using an inpainting technique. In one example, the computing device 201 is configured to perform inpainting for filling in a disoccluded area in the generated image associated with the current camera pose, wherein the inpainting is based on an image associated with the at least one camera pose. This means that inpainting may be based on the same image used for deprojection, or it may be another rendered image or several other images corresponding to a pose or poses of the camera. These other images may be associated with or corresponding to previous poses and/or predicted poses of the camera 102. Inpainting may be based on surface normal information. The surface normal information may comprise normals associated with a surface of an object(s) of the image. Surface normal information may be extracted from the relevant rendered image and applied to the generated image so as to fill in any disocclusions.

Additionally, albedo and/or ambient occlusion information of the image associated with the at least one camera pose may be used for filling in a disoccluded area in the generated image. This means that albedo and/or ambient occlusion information of the image on which the generated image is based is extracted and applied to the generated image so as to fill in any disocclusions. Similarly to surface normal information, albedo and/or ambient occlusion information may be extracted from another rendered image different to the rendered image on which the generated image is based.

Surface normal information, albedo and/or ambient occlusion information form part of a G-buffer in a technique referred to as deferred rendering. As such, in one example, inpainting is based on the G-buffer(s) of the rendered image on which the generated image is based and/or any of the other rendered images.

By using the G-buffer, albedo, normal and/or ambient occlusion information, as described above the disocclusions can be filled in in real time and images can be blended accounting for subtle changes in lighting between said images. By using the albedo, normal and/or ambient occlusion information, the exact impact a scene's lighting affects each pixel can be determined and accounted for, and a more seamless blend between images can be achieved as a result.

In one example, additional or alternative inpainting technique may be applied. For example, a screen crack filling method may be applied where small disocclusions a few pixels wide can be filled by inferring the most appropriate pixel value using valid neighbouring pixels.

It should be understood that any combination of inpainting techniques can be applied or used to the generated image. Further, any inpainting technique or a combination thereof can be applied or used regardless if the generated image was generated through pixel reprojection or mesh reprojection as described herein.

The above-described computing device 201 may form part of a system for generating an image. Such a system comprises a display for displaying the rendered image, and a camera configured to capture the rendered image displayed on the display similar to the illustration of FIG. 2a. In one example, the computing device 201 may be configured to determine a plurality of camera poses and render an image for each camera pose. The camera comprises at least one sensor for detecting a current camera pose, and the camera is configured to transmit its current pose to the computing device. The computing device is further configured to select a determined camera pose of the plurality of camera poses closest in matching the current camera pose, and generate an image associated with the current camera pose based on at least one image of the plurality of determined camera poses. The display 106 is configured to display the generated image whilst the camera is in its current pose and captures the generated image. The computing device 201 of the system may comprise any of the features, or any combination of features, described above in relation to FIG. 2a.

An advantage of the computing device 201 is that less computational resources are required and the latency is reduced when projecting images on a display in real time whilst providing a convincing perspective and parallax effect. This is particularly useful in applications where live action is composited with virtual content in real time.

Real time as used herein may be understood as rendering and/or generating images at a corresponding frame rate (e.g. several tens of frames per second) to the frame rate at which frames/images are displayed by a display.

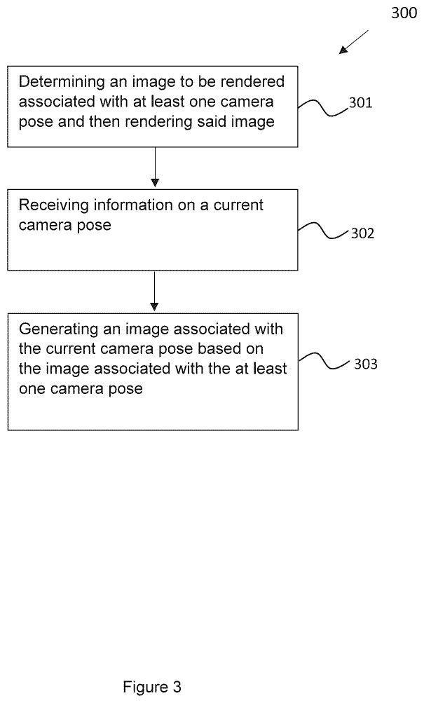

A method 300 for generating an image configured to be captured by a camera will now be described with reference to FIG. 3. Any alternatives, combinations or variations described with reference to FIG. 2a are also applicable to the method 300 of FIG. 3. The method 300 may be performed by a computing device as described in relation to FIG. 2a.

FIG. 3 discloses various operations of method 300. The method 300 comprises determining an image to be rendered associated with at least one camera pose and then rendering said image 301. The method 300 further comprises receiving information on a current camera pose 302 and generating an image associated with the current camera pose based on the image associated with the at least one camera pose 303. Operation 302 may occur before operation 301 or simultaneously as operation 301. The perspective of the image associated with the current camera pose may be different to the perspective of the image of the at least one camera pose.

The method 300 may further comprise generating the image associated with the current camera pose based on depth information and/or geometric information, or any other scene geometry representation, of the image associated with the at least one camera pose.

The method 300 may also comprise generating the image associated with the current camera pose by deprojecting content of the image associated with the at least one camera pose from a 2D screen space to its position in a 3D world space using an inverse of the at least one camera pose's view projection matrix, and applying a view projection matrix of the current camera pose to the position of the content in the 3D world space so that the image of the current camera pose can be reprojected in a 2D screen space.

The deprojection of the image associated with the at least one camera pose and the reprojection of the image associated with the current camera pose as described in the preceding paragraph can be performed using either pixel reprojection or mesh reprojection as described herein.

In one example, the at least one camera pose comprises a plurality of camera poses, and the method 300 may further comprise rendering a plurality of images each of which is associated with a corresponding camera pose, based on the received information on the current camera pose, the method may further comprise selecting the camera pose of the plurality of camera poses closest to the current camera pose. The method may then further comprise generating an image associated with the current camera pose based on the selected camera pose and at least one further image associated with the plurality of camera poses.

Generating the image associated with the current camera pose may comprise deprojecting content of the image associated with the selected predicted camera pose from a 2D screen space to its position in a 3D world space using an inverse of the selected predicted camera pose's view projection matrix, and applying a view projection matrix of the current camera pose to the position of the content in the 3D world space so that the image of the current camera pose can be reprojected in a 2D screen space.

The deprojection of the image associated with the selected predicted camera pose and the reprojection of the image associated with the current camera pose as described in the preceding paragraph can be performed using either pixel reprojection or mesh reprojection as described herein.

The method may further comprise performing inpainting for filling in a disoccluded area in the generated image associated with the current camera pose, wherein the inpainting is based on an image associated with the at least one camera pose. The inpainting may be based on surface normal information, albedo and/or ambient occlusion information of the image associated with the at least one camera pose as discussed in relation to FIG. 3.

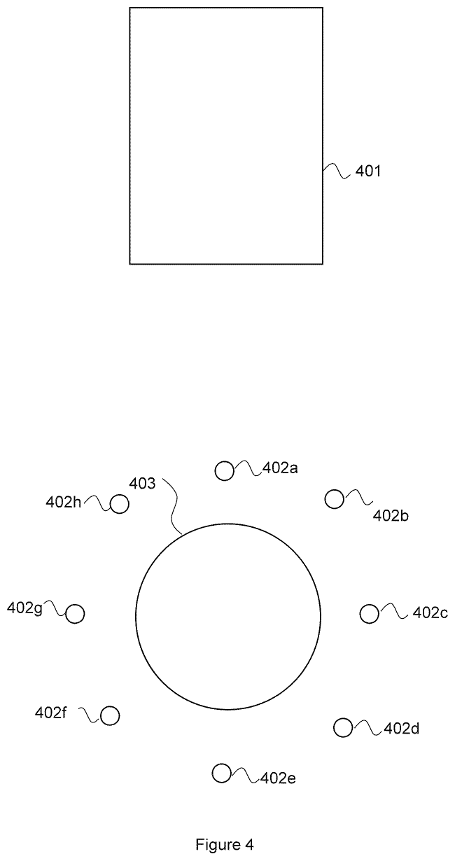

Referring now to FIG. 4, a computing device 401 is disclosed. The computing device 401 is for generating an image for displaying on a user device. The user device may be referred to as a first device. The computing device 401 may be the same computing device 201 as described above, and/or it may be a server, several servers, a compositing server, rendering server, dedicated server, computer or other hardware that has computational capabilities. The computing device may comprise an input and an output interface for communicating with other components such as a user device 402a-402h. A user device may be a mobile phone, tablet, mounted head display, extended reality glasses or similar computing device having a display which is configured to display rendered content.

The computing device 401 is configured to determine a pose of a first device 402a having a display and identify at least one second device 402b having a display, wherein the at least one second device has a pose different to the first device. The computing device 401 is further configured to render an image associated with the pose of the at least one second device 402b, and generate an image associated with the pose of the first device 402a based on the image associated with the pose of the at least one second device 402b. The perspective of the image of the first device 402a may be different to the perspective of the image of the at least one second device 402b.

A pose of a device such as a user device is to be understood as a location and/or orientation of the device. In some examples, a pose of a device should specifically be understood as a location and/or orientation of a display of the device. The pose of the device may be tracked using an accelerometer, gyroscope, GPS and/or simultaneous localisation and mapping (SLAM) or other suitable technology. The device 402a-402h or relevant SLAM component may send their pose to the computing device 401 such that the computing device receives information on a current device pose or previous device pose(s).

The computing device 401 may be further configured to generate the image associated with the pose of the first device 402a by using depth information and/or geometric information of the image associated with the pose of the at least one second device 402b. Similar to the examples of FIGS. 2 and 3, the depth information indicates the distance of a pixel from the user device and in deferred rendering it is included in a depth buffer or G-buffer. Geometric information indicates edges and/or vertices of an object(s) in an image. In some examples, the computing device 401 is configured to generate the image associated with the current camera pose based on any scene geometry representation, for example, depth information as previously described or a mesh comprising information on vertices and faces.

The computing device 401 may be configured to generate an image in a similar manner to computing device 201. More specifically, the computing device 401 is configured to generate the image associated with the pose of the first device 402a by deprojecting content of the image associated with the pose of the at least one second device 402b from a 2D screen space to its position in a 3D world space using an inverse of the at least one second device's view projection matrix, and applying a view projection matrix of the first device 402a to the position of the content in the 3D world space so that the image of the first device 402a can be reprojected in a 2D screen space. This may further be explained as inverting the view projection matrix of the at least one second device 402b and multiplying the matrix with the x, y, and z coordinates of each pixel of the 2D screen space (here the z-coordinates may correspond or be determined by the depth information, which may be included in the depth buffer, G-buffer, depth map or any other scene geometry representation as described above). This causes each pixel to be returned to its original x, y, z location in a 3D world space. The locations of each original x, y, z location in a 3D world space are then multiplied with the view projection matrix of the first device 402a so that the image of the first device 402a can be reprojected in a 2D screen space with the right perspectives. Thereafter, inpainting may be applied as is described below.

The deprojection of the image associated with the pose of the at least one second device and the reprojection of the image associated with the pose of the first device as described in the preceding paragraph can be performed using either pixel reprojection or mesh reprojection as described herein.

When the at least one second device comprises a plurality of second devices 402b-402h, the computing device 401 may be configured to render an image for each second device such that a plurality of images is rendered, determine the pose of each second device and select the second device 402b having a pose closest to the pose of the first device 402a. Thereafter, the computing device may be configured to generate an image associated with the first device 402a based on the image of the selected second device 402b and at least one further image associated with another second device. It should be understood that the selected second device 402b does not necessarily have to be the device closest matching the pose of the first device 402a, instead the selected second device can be the device that just closely matches the pose of the first device 402a.

The computing device 401 may be configured to generate an image applying the same deprojection and reprojection steps as described above. Thereafter, inpainting may be applied as will now be described.

As the generated image of the first device 402a has a different perspective to the rendered image of the second device 402b on which it is based, there may be disocclusions appearing in the generated image. Disocclusions may be avoided or reduced by using the mesh reprojection described herein where the final pixel position or rather pixel colour is determined through interpolation. Additionally or alternatively, disocclusions may be filled in real time using an inpainting technique, or a combination of inpainting techniques. In one example, the computing device 401 is configured to perform inpainting for filling in a disoccluded area in the generated image associated with the first device, using information from an image associated with the at least one second device. This means that inpainting may be based on the same image of the secondary device 402b used for deprojection, or it may be another rendered image or several other images corresponding to other second devices 402b-402h.

Inpainting may be based on surface normal information of the image of the at least one second device. In particular, it may comprise extracting surface normal information from the image of the at least one second device and applying it to the generated image.

Additionally, albedo and/or ambient occlusion information of the image associated with the at least one second device may be used as inpainting. This means that albedo and/or ambient occlusion information of the image on which the generated image is based is extracted and applied to the generated image so as to fill in any disocclusions. Similarly to surface normal information, albedo and/or ambient occlusion information may be extracted from another rendered image different to the rendered image on which the generated image is based.

As described above, surface normal information, albedo and/or ambient occlusion information form part of a G-buffer in a technique referred to as deferred rendering. As such, in one example, inpainting is based on the G-buffer(s) of the rendered image on which the generated image is based and/or any of the other rendered images.

By using the G-buffer, albedo, normal and/or ambient occlusion information, as described above the disocclusions can be filled in in real time and images can be blended accounting for subtle changes in lighting between said images. By using the albedo, normal and ambient occlusion information, the exact impact a scene's lighting affects each pixel can be determined and accounted for, and a more seamless blend between images can be achieved as a result.

In one example, the computing device 401 is configured to apply additional or alternative inpainting technique. For example, a screen crack filling technique may be applied where small disocclusions a few pixels wide can be filled by inferring the most appropriate pixel value using valid neighbouring pixels.

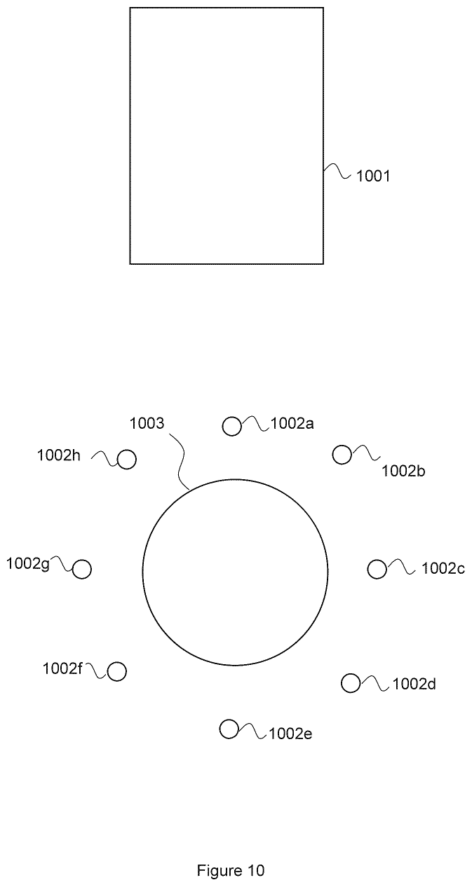

The above example is particularly useful when there are several devices or user devices as shown in FIG. 4 as well as FIG. 10. Here, there may be several user devices 402a-402h that simultaneously display rendered content of a performance or show on stage 403 in real time. Rather than rendering an image for each user device in real time, which requires vast amount of computation power and burdens the network, images can be generated by a computing device as described above based on rendered images of neighbouring perspectives which requires less computational resources.

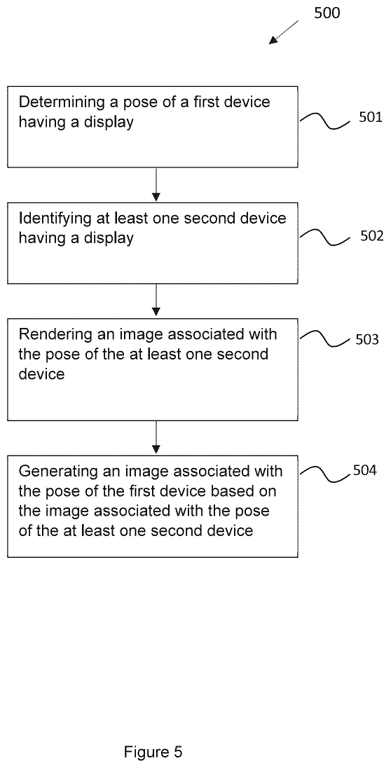

A method 500 for generating an image for displaying on a first device will now be described with reference to FIG. 5. Any alternatives, combinations or variations described with reference to FIG. 4 are also applicable to the method 500 of FIG. 5. The method 500 may be performed by a computing device as described in relation to FIG. 4.

FIG. 5 discloses various operations of method 500. The method 500 comprises determining a pose of a first device having a display 501, and identifying at least one second device having a display 502, wherein the at least one second device has a pose different to the first device. The method 500 further comprises rendering an image associated with the pose of the at least one second device 503, and generating an image associated with the pose of the first device based on the image associated with the pose of the at least one second device 504.

The method 500 may further comprise generating the image associated with the pose of the first device by using depth information and/or geometric information, or any other scene geometry representation, of the image associated with the pose of the at least one second device.

In one example, the method 500 may comprise generating the image associated with the pose of the first device by deprojecting content of the image associated with the pose of the at least one second device from a 2D screen space to its position in a 3D world space using an inverse of the at least one second device's view projection matrix, and applying a view projection matrix of the first device to the position of the content in the 3D world space so that the image of the first device can be reprojected in a 2D screen space.

The deprojection of the image associated with the pose of the at least one second device and the reprojection of the image associated with the pose of the first device as described in the preceding paragraph can be performed using either pixel reprojection or mesh reprojection as described herein.

In one example, the at least one second device comprises a plurality of second devices differing in poses, and the method 500 comprises rendering an image associated with each second device such that a plurality of images is rendered, determining the pose of each plurality of second devices, and selecting the second device closest in matching the pose of the first device, and generating an image associated with the first device based on the image of the selected second device and at least one further image associated with another second device. In this example, the method 500 may also comprise generating the image associated with the pose of the first device by deprojecting content of the image associated with the pose of the selected second device from a 2D screen space to its position in a 3D world space using an inverse of the second device's view projection matrix, and applying a view projection matrix of the first device to the position of the content in the 3D world space so that the image of the first device can be reprojected in a 2D screen space. Also, here the reprojection of the image can be performed using pixel reprojection or mesh reprojection as described herein.

The method 500 may further comprise inpainting information for filling in a disoccluded area in the generated image associated with the first device, wherein the inpainting is based on an image associated with at least one second device. The inpainting may be based on surface normal information of an object in the image associated with the at least second device. The surface normal information may be extracted from the image associated with the at least second device and applied to the generated image. The inpainting may further comprise albedo and ambient occlusion information of the image associated with the least one second device. The albedo and ambient occlusion information may be extracted from the image associated with the at least one second device and applied to the generated image.

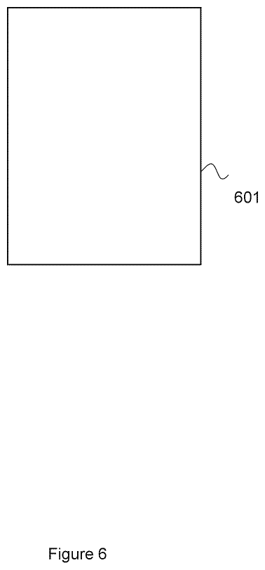

Another example will now be described with reference to FIG. 6. FIG. 6 shows a computing device 601 for generating an image. The computing device may be a server, several servers, a compositing server, rendering server, dedicated server, computer or other hardware that has computational capabilities. The computing device 601 is configured to receive a first image depicting an object from a perspective, generate a new image based on depth information and/or geometric information of the first image, wherein the new image is depicting the object from a different perspective to the first image, and perform inpainting for filling in a disoccluded area in the new image, wherein the inpainting is based on surface normal information of an object in the first image.

The computing device may generate a new image based on depth information and/or geometric information of the first image according to any examples or combination of examples described herein. Furthermore, the computing device may perform inpainting according to any examples or combination of examples described herein.

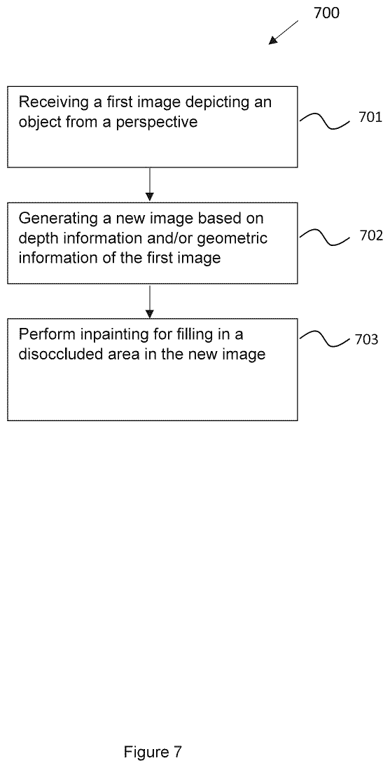

A method 700 for generating an image will now be described with reference to FIG. 7. Any alternatives, combinations or variations described with reference to FIG. 6 are also applicable to the method 700 of FIG. 7. The method 700 may be performed by a computing device as described in relation to FIG. 6.

Method 700 comprises receiving a first image depicting an object from a perspective 701, generating a new image based on depth information and/or geometric information of the first image, wherein the new image is depicting the object from a different perspective to the first image, and perform inpainting for filling in a disoccluded area in the new image 703, wherein the inpainting is based on surface normal information of an object in the first image.

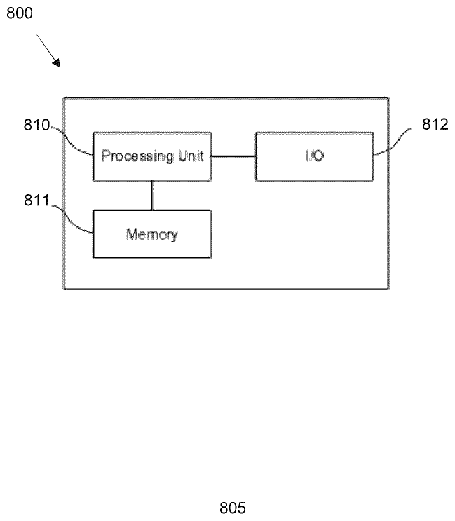

The methods of the present disclosure, as illustrated by the above examples, may be conducted by a computing device. The methods may be conducted on receipt of suitable computer readable instructions, which may be embodied within a computer program running on a computing device. Such a computing device 800 is illustrated in FIG. 8 and it may comprise a processing unit 810 and a memory 811. The computing device 800 may further comprise an input/output (I/O) interface 812. The processing unit 810 may include any suitable processer and/or combination of processors. For example, the processing unit 810 may include one or more of a Central Processing Unit (CPU) and a Graphical Processing Unit (GPU). The memory 811 may include volatile memory and/or non-volatile/persistent memory. The memory 811 may, for example, be used to store data such as an operating system, instructions to be executed by the processing unit (e.g. in the form of software to be executed by the processing unit), configuration information related to the computing device 800 and/or data related to an image to be rendered and/or generated. The memory may contain instructions executable by the processing unit 810 such that the computing device is operative to carry out any methods described herein, in particular method 300, method 500 and/or method 700.

At least the processing unit 810 may be connected to an input/output (I/O) interface 812. The I/O interface 812 facilitates communication with one or more other devices, network nodes or modules in a network. For example, the I/O interface 812 may be operable to transmit and/or receive communications to/from other devices in a network. In some examples, the I/O interface 812 may be operable to transmit and/or receive communications over an air interface. For example, the I/O interface 812 may include a transmitter and/or a receiver for transmitting and/or receiving wireless communication (e.g. radio frequency signals). In some examples, the I/O interface 812 may include a transceiver configured to receive and transmit wireless communication (e.g. radio frequency signals). In some examples, the I/O interface 812 may be operable to additionally or alternatively communicate over one or more wired connections.

Optionally, the device 800 may further include a display. For example, the device 800 may include a display for displaying information to a user of the device 800. The information may be rendered content/image or a generated image as created according to the examples described herein. The display may comprise any suitable electronic display. The display may be connected to at least to the processing unit 810. The processing unit 810 may generate display signals which are sent to the display in order to cause the display to display information.

It will be appreciated that embodiments of the present disclosure can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present disclosure. Accordingly, embodiments provide a program comprising code for implementing a system or method as claimed in any preceding claim and a machine readable storage storing such a program. Still further, embodiments of the present disclosure may be conveyed electronically via any medium such as a communication signal carried over a wired or wireless connection and embodiments suitably encompass the same.

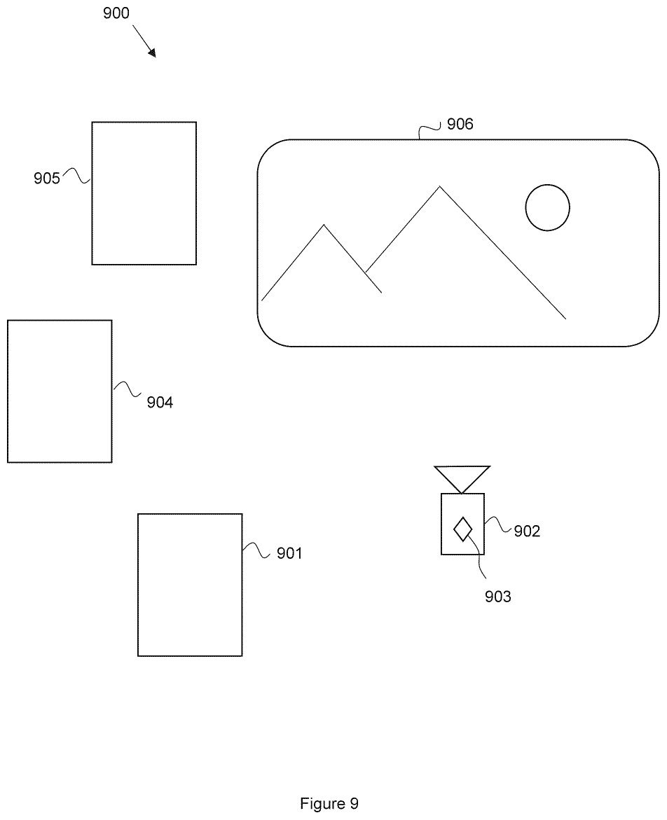

Examples of how the above-described computing devices, systems and methods can be implemented will now be described with reference to FIGS. 9 and 10.

FIG. 9 illustrates a system 900 comprising a network of components that can communicate with one another through a wired and/or wireless connection using TCP/IP messaging protocols. The components of the system 900 include a compositing server 901 which acts a central hub of the system, a camera 902 configured to communicate with the main compositing server 901, a tracker 903 configured to track the pose and optionally also the intrinsics of the camera 902. The tracker 903 may be a gyroscope, accelerometer and/or GPS or similar attached to the camera 902. It should be understood that instead of a tracker attached to a camera, simultaneous localization and mapping (SLAM) techniques or other tracking technique may be used to track the pose and intrinsics of the camera. The components of the system 900 further include a dedicated server 904 configured to receive the tracked pose and optionally also intrinsics of the camera as tracking information. The dedicated server 904 is further configured to record the tracking information and transmit it to the compositing server 101. The system also comprises a rendering server 905 configured to render images of virtual content and transmitting the rendered images to the compositing server 101. It should be understood that compositing server 901, the dedicated server 904 and the rendering server 905 can be implemented into a single server or distributed across multiple servers. The system 900 further comprises a display 906, for example an LED display, for projecting or displaying the rendered images.

In use, the camera's 902 pose and optionally also intrinsics are tracked using the tracker 903. This means that the compositing server 901 (or one of the other servers) can be provided with a recent history of poses and optionally also intrinsics of the camera 902. Based on this, an upcoming camera pose can be predicted. In one example, several or a series of upcoming camera poses can be predicted along the trajectory of the predicted movement. The rendering server 905 then renders an image for each predicted camera pose. The number of predicted poses may be determined based on the available computational power whilst maintaining real-time rendering speeds.

In one example, only a single camera pose may be predicted.

The rendered image or images may comprise virtual content each of which is associated with its camera pose and optionally also intrinsics, as well as information describing the image's geometry and depth. For example, in deferred rendering, the information describing the depth of an image may be included in a G-buffer or G-buffers, or more specifically a depth buffer.

Once the image or images have been rendered, the tracker 903 determines the camera's 902 current or actual pose. In the event that several images have been rendered, then the compositing server 901 (or one of the other servers) determines which of the predicted poses that is closest to the actual pose of the camera 902 and selects the image associated with the selected predicted pose as forming the basis for a new synthesised or generated image that is to correspond to the actual pose or perspective of the camera 902. In the case of just a single image being rendered, then this image becomes the selected image.

The new generated image is created by using depth information and/or geometric information, or any other scene geometry representation, of the selected image. The depth information may be a depth buffer as used in deferred rendering, or it may be a depth map as used in other rendering techniques. Generating the image using depth information and/or geometric information of the selected image will now be described in further detail.

The content of the selected image is deprojected from a 2D screen space to its position in a 3D world space using an inverse of the view projection matrix of the selected camera pose. A view projection matrix of the actual camera pose is then applied to the position of the content in the 3D world space so that the image of the actual camera pose can be reprojected in a 2D screen space. This may further be explained as inverting the view projection matrix of the camera pose associated with the selected image and multiplying the matrix with the x, y, and z coordinates of each pixel of the 2D screen space (here the z-coordinates may correspond or be determined by the depth information, which may be included in the depth buffer, G-buffer, depth map or any other scene geometry representation as described above). This causes each pixel to be returned to its original x, y, z location in a 3D world space. The locations of each original x, y, z location in a 3D world space are then multiplied with the view projection matrix of the actual camera pose so that the image of the actual pose can be reprojected in a 2D screen space with the right perspectives.

The deprojection of the image associated with the selected camera pose and the reprojection of the image associated with the actual camera pose as described in the preceding paragraph can be performed using either pixel reprojection or mesh reprojection as described herein.

The new generated image is of a perspective of the current or actual camera pose and so when displayed on the display 906 the perspective and parallax effects appear convincing and realistic. By generating an image based on an already rendered image as described above, less computational power is required compared to rendering a new image. Additionally, it is much faster generating a new image than rendering a new image and so latency is also reduced.

The new generated image may be created by the compositing server 901, rendering server 905, dedicated server 904, or any of the computing devices described herein.

In the case where several camera poses have been predicted, then it should be understood that the generated image does not have to be based on the image associated with the predicted pose that is closest to the actual pose of the camera 902. The generated image can instead be based on an image associated with a predicted pose that is close, not the closest, to the actual pose of the camera 902. Alternatively, the generated image does not have to be based on an image associated with a predicted pose but instead be based on an image associated with the last known pose, or one of the last known poses of the camera 902. In this example, the compositing server 901 would not predict camera poses but instead just use the history of camera poses when generating an image for the actual camera pose. This is particularly useful when an image has been rendered and the camera's pose is slightly changed.

As the generated image has a different perspective to the rendered image on which it is based, there may be disocclusions appearing in the generated image. Disocclusions may be avoided or reduced by using mesh reprojection described herein where the final pixel position or rather pixel colour is determined through interpolation. Additionally or alternatively, disocclusions may be filled in real time using an inpainting technique. The inpainting technique may be using screen crack filling methods where small disocclusions a few pixels wide can be filled by inferring the most appropriate pixel value using valid neighbouring pixels. Another inpainting technique that may be applied to the generated image is using normals of the selected image and/or any of the other rendered images. The normals are surface normals of an object and may be described as normal information. Additionally, albedo and/or ambient occlusion information of the selected image and/or any of the other rendered images (predicted or past) may be used as described with reference to the other examples herein.

By using G-buffer, albedo, normal and/or ambient occlusion information, the disocclusions can be filled in in real time and images can be blended accounting for subtle changes in lighting between images. By using the albedo, normal and ambient occlusion information, the exact impact the scene's lighting affect each pixel can be determined and accounted for, and a more seamless blend between images can be achieved as a result.

It should be understood that any combination of inpainting techniques can be applied or used to the generated image.

The generated image is then displayed on the display 906 and the camera 902 can capture or film the display 906 as well as any actors performing a scene and props positioned in front of the display 906. The perspective of the camera 902 will match the perspective of the generated image displayed on the screen because the generated image is faster to create than rendering a new image. Additionally, generating an image as described herein requires less computational power compared to rendering a new image.

Other examples of how the computing devices, systems and methods described herein can be implemented will now be described with reference to FIG. 10.

FIG. 10 illustrates a computing device 1001 for rendering and transmitting images to user devices 1002. The user devices 1002 may be mobile phones, tablets, mounted head displays, extended reality glasses or similar computing device having a display which is configured to display rendered content. The user devices may simultaneously display rendered content of a performance or show such that users of the user devices form part of an audience. The user devices may be spaced around a real or a virtual stage 1003 as seen in FIG. 10, or the user devices may be located, virtually or in reality, on one side of a stage in the more traditional sense. The user devices may be static or moveable relative to the stage and/or one another. The stage 1003 can be of any shape.

In this example, the pose of a first user device 1002a is determined and then a second user device 1002b is identified. The second user device 1002b may be a user device out of a plurality of user devices that has a pose closest to that of the first user device 1002a. An image is then rendered or already has been rendered for the second user device 1002b. The image of the second user device 1002b is of a perspective corresponding to the pose of the second user device 1002b. To generate an image for the first user device 1002a, the image of the second user device 1002b can be used similar to the example shown in FIG. 9. More specifically, the new generated image is created by using depth information and/or geometric information, or other suitable scene geometry representation, of the rendered image of the second user device 1002b. The depth information may be a depth buffer as used in deferred rendering, or it may be a depth map as used in other rendering techniques. Generating the image using depth information and/or geometric information of the rendered image of the second user device 1002b will now be described in further detail.

The content of the image associated with the second user device 1002b is deprojected from a 2D screen space to its position in a 3D world space using an inverse of the view projection matrix of the second user device 1002b. A view projection matrix of the first device 1002a is then applied to the position of the content in the 3D world space so that the image of the first user device 1002a can be reprojected in a 2D screen space. This may further be explained as inverting the view projection matrix of the second user device 1002b and multiplying the matrix with the x, y, and z coordinates of each pixel of the 2D screen space (here the z-coordinates may correspond or be determined by the depth information, which may be included in the depth buffer, G-buffer, depth map or any other scene geometry representation as described above). This causes each pixel to be returned to its original x, y, z location in a 3D world space. The locations of each original x, y, z location in a 3D world space are then multiplied with the view projection matrix of the first user device 1002a so that the image of the first user device 1002a can be reprojected in a 2D screen space with the right perspectives.

The deprojection of the image associated with the pose of the second user device and the reprojection of the image associated with the pose of the first user device as described in the preceding paragraph can be performed using either pixel reprojection or mesh reprojection as described herein.

The same inpainting methods can then be applied to the image of the first user device 1002a as those described with reference to FIG. 9 or any of the other examples described herein. In particular, normals, albedo and/or ambient occlusion information may be extracted from the rendered image of the second user device 1002b, and/or it can be extracted from a rendered image of another user device, of example another nearby user device 1002h. The extracted normals, albedo and/or ambient occlusion information can then be applied to the generated image of the first user device 1002a to fill in any disocclusions.

It should be appreciated that the examples of FIG. 9 can also be applied to the use case of FIG. 10 in that an image associated with a moving user device 1002a can be generated based on a rendered image of its last or close to last pose and/or its predicted pose(s).

For the examples of this disclosure, it should be understood that generating an image by deprojecting a rendered image and reprojecting a new image as described above does not have to be applied to the entire rendered image, but instead to a part of the rendered image. For example, some parts of the rendered image that is deprojected may have depth values that would place a pixel so far away from the camera or user device that a small change in perspective between the rendered image and generated image would have no noticeable effect on parallax. In such cases, the pixel of the rendered image be reused in the generated image.

The examples disclosed herein enable an image or a viewpoint to be generated based on a previously rendered image regardless of change in perspective. Disocclusions in the generated image may be avoided or reduced by using mesh reprojection as described herein where the final pixel position or rather pixel colour is determined through interpolation. Additionally or alternatively, the generated image can be improved in that it can be made more realistic by applying inpainting based on normal of the rendered image and/or other neighbouring rendered images. By generating a convincing image with correct perspective and parallax effects as described herein, the computational powers required for playing or displaying a scene on a display can be reduced.

Features, integers, characteristics, or groups described in conjunction with a particular aspect, embodiment or example of the disclosure are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The disclosure is not restricted to the details of any foregoing examples.

1. A computing device for generating an image configured to be captured by a camera, the computing device being configured to;
determine an image to be rendered associated with at least one camera pose and then render said image,
receive information on a current camera pose, and
generate an image associated with the current camera pose based on a rendered image associated with the at least one camera pose.

2. A computing device according to claim 1, wherein a perspective of the image associated with the current camera pose is different to the perspective of the rendered image of the at least one camera pose.

3. A computing device according to claim 1, wherein the computing device is configured to generate the image associated with the current camera pose based on depth information and/or geometric information of the rendered image associated with the at least one camera pose.

4. A computing device according to claim 1, wherein the at least one camera pose is a predicted at least one camera pose or a previous camera pose.

5. (canceled)

6. A computing device according to claim 1, wherein the computing device is configured to generate the image associated with the current camera pose by deprojecting content of the image associated with the at least one camera pose from a two-dimensional screen space to its position in a three-dimensional world space using an inverse of the at least one camera pose's view projection matrix, and applying a view projection matrix of the current camera pose to the position of the content in the three-dimensional world space so that the image of the current camera pose can be projected in a two-dimensional screen space.

7. A computing device according to claim 6, wherein the computing device is further configured to divide the image associated with the at least one camera pose into a mesh, perform deprojection by warping and moving the mesh based on a depth map of the image and use the inverse of the at least one camera pose's view projection matrix, and then apply the view projection matrix of the current camera pose so that the image can be projected in a two-dimensional screen space.

8. A computing device according to claim 1, wherein the at least one camera pose comprises a plurality of camera poses, the computing device being configured to render a plurality of images each of which is associated with a corresponding camera pose,
based on the received information on the current camera pose, select the camera pose of the plurality of camera poses closest in matching the current camera pose, and
generate an image associated with the current camera pose based on the selected camera pose and at least one further image associated with the plurality of camera poses.

9. A computing device according to claim 8, wherein the computing device is configured to generate the image associated with the current camera pose by deprojecting content of the image associated with the selected camera pose from a two-dimensional screen space to its position in a three-dimensional world space using an inverse of the selected camera pose's view projection matrix, and applying a view projection matrix of the current camera pose to the position of the content in the three-dimensional world space so that the image of the current camera pose can be projected in a two-dimensional screen space.

10. A computing device according to claim 9, wherein the computing device is further configured to divide the image associated with the selected camera pose into a mesh, perform deprojection by warping and moving the mesh based on a depth map of the image and use the inverse of the view projection matrix of the selected camera pose, and then apply the view projection matrix of the current camera pose so that the image can be projected in a two-dimensional screen space.

11. A computing device according to claim 1, further configured to perform inpainting for filling in a disoccluded area in the generated image associated with the current camera pose, wherein the inpainting is based on an image associated with the at least one camera pose.

12. A computing device according to claim 11, wherein the inpainting is based on surface normal information of an object in the image associated with the at least one camera pose.

13. (canceled)

14. A system comprising a computing device for generating an image, a display for displaying the rendered image, and a camera configured to capture the rendered image displayed on the display;
the computing device being configured to determine a plurality of camera poses and render an image for each camera pose,
the camera comprising at least one sensor for detecting a current camera pose, and the camera being configured to transmit its current pose to the computing device,
the computing device being further configured to;
select a determined camera pose of the plurality of camera poses closest in matching the current camera pose, and
generate an image associated with the current camera pose based on at least one image of the plurality of determined camera poses, and
the display being configured to display the generated image whilst the camera is in its current pose and captures the generated image.

15. A computing device for generating an image for displaying on a first device, the computing device being configured to;
determine a pose of a first device having a display,
identify at least one second device having a display, wherein the at least one second device has a pose different to the first device,
render an image associated with the pose of the at least one second device,
generate an image associated with the pose of the first device based on the image associated with the pose of the at least one second device.

16. A computing device according to claim 15, wherein the computing device is configured to generate the image associated with the pose of the first device by using depth information and/or geometric information of the image associated with the pose of the at least one second device.

17. A computing device according to claim 15, wherein the computing device is configured to generate the image associated with the pose of the first device by deprojecting content of the image associated with the pose of the at least one second device from a two-dimensional screen space to its position in a three-dimensional world space using an inverse of the at least one second device's view projection matrix, and applying a view projection matrix of the first device to the position of the content in the three-dimensional world space so that the image of the first device can be projected in a two-dimensional screen space.

18. A computing device according to claim 17, wherein the computing device is further configured to divide the image associated with the pose of the at least one second device into a mesh, perform deprojection by warping and moving the mesh based on a depth map of the image and use the inverse of the view projection matrix associated with the pose of the at least one second device, and then apply the view projection matrix of the pose of the first device so that the image can be projected in a two-dimensional screen space.

19. A computing device according to claim 15, wherein the at least one second device comprises a plurality of second devices differing in poses, and the computing device is configured to render an image associated with each second device such that a plurality of images is rendered,
determine the pose of each plurality of second devices, and select the second device closest in matching the pose of the first device, and
generate an image associated with the first device based on the image of the selected second device and at least one further image associated with another second device.

20. A computing device according to claim 16, wherein the computing device is configured to generate the image associated with the pose of the first device by deprojecting content of the image associated with the pose of the selected second device from a two-dimensional screen space to its position in a three-dimensional world space using an inverse of the second device's view projection matrix, and applying a view projection matrix of the first device to the position of the content in the three-dimensional world space so that the image of the first device can be projected in a two-dimensional screen space.

21. A computing device according to claim 20, wherein the computing device is further configured to divide the image associated with the pose of the selected second device into a mesh, perform deprojection by warping and moving the mesh based on a depth map of the image and use the inverse of the view projection matrix associated with the pose of the selected second device, and then apply the view projection matrix of the first device so that the image can be projected in a two-dimensional screen space.

22. A computing device according to claim 15, further configured to perform inpainting information for filling in a disoccluded area in the generated image associated with the first device, wherein the inpainting is based on an image associated with at least one second device.

23. (canceled)

24. (canceled)

25. (canceled)
